(19) United States
(12) Patent Application Publication
(10) Pub. No.: US 2005/0168589 A1
(43) Pub. Date: Aug. 4, 2005

(54) Method and system for processing an image with an image-capturing device

(76) Inventors: D. Amnon Silverstein, Mountain View, CA (US); Daniel R. Tretter, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/769,652

(22) Filed: Jan. 30, 2004

(51) Int. Cl. H04N 5/225; H04N 5/76

(52) U.S. Cl. 348/220.1; 348/231.99; 348/222.1

(57) ABSTRACT

A first aspect of the present invention is a method for processing an image of a scene with an image-capturing device. The method includes sensing a plurality of frames of image data with the sensor, retrieving a sub-set of the image data, storing the sub-set of image data in a storage component of the image-capturing device and generating an image of the scene with the sub-set of image data.

### FIELD OF THE INVENTION

The present invention relates generally to the field of digital cameras and more particularly relates to a method and system for processing an image with an image-capturing device.

### BACKGROUND OF THE INVENTION

In digital cameras, images are represented by digital data and stored either in the camera's memory or an external memory device from which the images can be accessed by a user. A significant advantage to digital cameras is that users have the ability to manipulate the image data in a number of ways. Users are able to operate on and modify the images, transfer them to other devices, incorporate them into documents, display them in a variety of formats, etc. Thus, in comparison to analog cameras, digital cameras introduce a variety of capabilities and enhancements.

Typically, the digital camera incorporates a central processing unit, a memory, and many other features of a computer system. Accordingly, the digital camera is capable of concurrently running multiple software routines and subsystems to control and coordinate the various processes of the camera. One subsystem of particular interest is the image processing subsystem that is used for analyzing and manipulating captured image data in a variety of ways, including linearization, defect correction, white balance, interpolation, color correction, image sharpening, and color space conversion. In addition, the subsystem typically coordinates the functioning and communication of the various image processing stages and handles the data flow between the various stages.

Most digital cameras are similar in size to and behave like analog point—and shoot cameras. Unlike analog cameras, however, digital cameras are often equipped with a liquid-crystal display (LCD) screen on the back of the camera. Through the use of the LCD, digital cameras can operate in two modes, record and play, although some only have a record mode. In record mode, the LCD is used as a viewfinder in which the user may view an object or scene before taking a picture or while recording a video. In play mode, the LCD is used as a playback screen for allowing the user to review previously captured images either individually or in arrays of four, nine, or sixteen images.

Digital camcorders are technologically similar to digital cameras and are utilized to capture low-resolution video images as opposed to high-resolution still images. However, sometimes it is desirable to capture a high-resolution still image while simultaneously recording a low-resolution video. For example, if a video of a wedding is being digitally recorded, it might be desirable to simultaneously capture some high-resolution still-images of the wedding scene. Some existing camcorders can capture still images, but the resolution is limited. Moreover, a user must stop recording the video image in order to capture the still-image. Similarly, some existing digital cameras can capture video images but are not capable of capturing video images and still-images in a simultaneous fashion.

Accordingly, what is needed is a method and system for simultaneously capturing a still-image and a video image. Moreover, it is desirable that the method and system is simple, inexpensive and capable of being easily adapted to existing technology. The present invention addresses these needs.

### SUMMARY OF THE INVENTION

A first aspect of the present invention is a method for processing an image of a scene with an image-capturing device. The method includes sensing a plurality of frames of image data with the sensor, retrieving a sub-set of the image data, storing the sub-set of image data in a storage component of the image-capturing device and generating an image of the scene with the sub-set of image data.

Other aspects and advantages of the present invention will become apparent from the following detailed description, taken in conjunction with the accompanying drawings, illustrating by way of example the principles of the invention.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a flow chart of a method in accordance with an embodiment of the present invention.

FIG. 2 is a block diagram of an image-capturing device in accordance with an embodiment.

FIG. 3 is a block diagram of an imaging device in accordance with an embodiment of the present invention.

FIG. 4 is a block diagram of the internal computer in accordance with an embodiment of the present invention.

FIGS. 5(a)-5(c) show image configurations in accordance with an embodiment of the present invention.

FIG. 6 is an illustration of a frame-by-frame process in accordance with an embodiment of the present invention.

FIG. 7 is a flowchart of a frame-by-frame process that is utilized in conjunction with an embodiment of the present invention.

FIG. 8 shows a memory that includes high-resolution slices in accordance with an embodiment of the present invention.

FIG. 9 shows an image-processing module in accordance with an embodiment of the present invention.

FIG. 10 shows a configuration whereby an image-capturing device is coupled to a computer system in accordance with an embodiment of the present invention.

FIG. 11 shows a block diagram of an exemplary computer system that may be utilized in conjunction with embodiments of the present invention.

### DETAILED DESCRIPTION

The present invention relates to a method and system for processing an image with an image-capturing device. The following description is presented to enable one of ordinary skill in the art to make and use the invention and is provided in the context of a patent application and its requirements. Various modifications to the embodiments and the generic principles and features described herein will be readily apparent to those skilled in the art. Thus, the present invention is not intended to be limited to the embodiment shown but is to be accorded the widest scope consistent with the principles and features described herein.

As shown in the drawings for purposes of illustration, the present invention includes a method and system for processing an image of a scene with an image-capturing device. Accordingly, a user is allowed to simultaneously retrieve a high-resolution still-image of a scene while retrieving a low-resolution video image of the scene. By allowing a user to simultaneously retrieve a high-resolution still-image of a scene while retrieving a low-resolution video image of the scene, a user no longer has to switch back and forth between a video image mode and a still-image mode in order to retrieve a high-resolution still image of a scene.

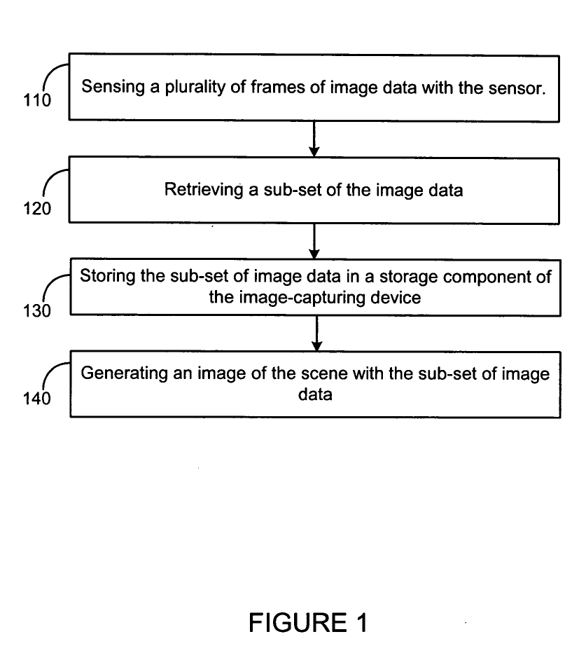

FIG. 1 is a flow chart of a method for processing an image of a scene with an image-capturing device. A first step 110 includes sensing a plurality of frames of image data with the sensor. A second step 120 includes retrieving a sub-set of the image data. A third step 130 includes storing the sub-set of image data in a storage component of the image-capturing device. A final step 140 includes generating an image of the scene with sub-set of image data.

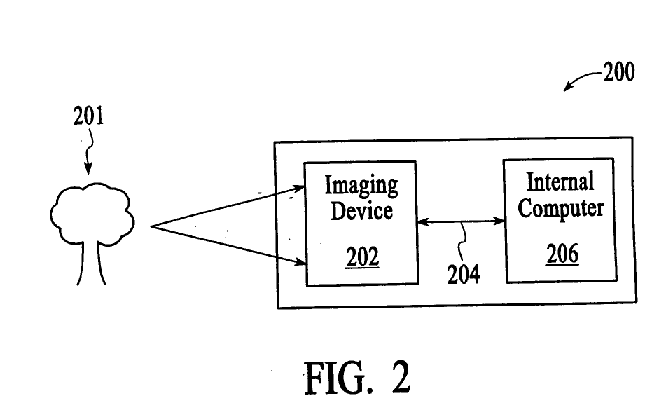

In an embodiment, steps 110-140 are accomplished utilizing an image-capturing device such as digital camera, digital camcorder or the like. For an example of such a device, please refer now to FIG. 2. FIG. 2 is a block diagram of an image-capturing device 200 in accordance with an embodiment. Image-capturing device 200 includes an imaging device 202, a system bus 204 and a computer 206. The imaging device 202 is optically coupled to a scene 201 and electronically coupled via system bus 204 to computer 206.

Although the above-disclosed embodiment of the image capturing device is described in the context of being a digital camera, one of ordinary skill in the art will readily recognize that the image-capturing device could be a mobile phone, a personal-digital assistant (PDA) or a variety of other devices while remaining within the spirit and scope of the present invention.

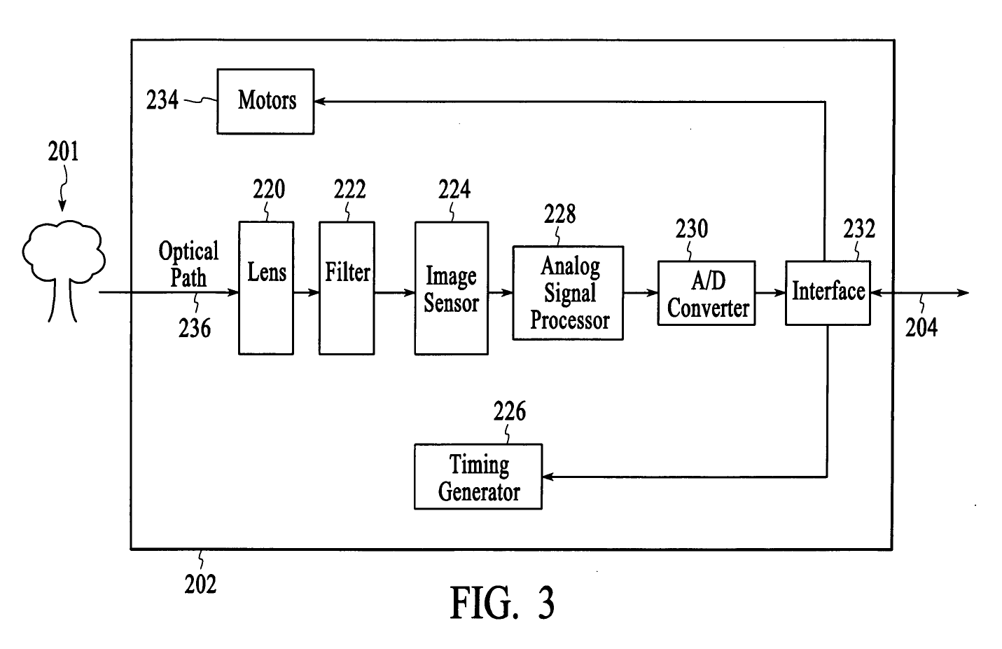

Referring now to FIG. 3, a block diagram of another embodiment of the imaging device 202 is shown. Imaging device 202 includes a lens 220 having an iris, a filter 222, an image sensor 224, a timing generator 226, an analog signal processor (ASP) 228, an analog-to-digital (A/D) converter 230, an interface 232 and one or more motors 234.

During operation, imaging device 202 retrieves an image of scene 201 via reflected light impacting image sensor 224 along optical path 236. Image sensor 224 responsively generates a set of raw image data representing the retrieved image. The analog output of the image sensor 224 is amplified and processed by ASP 228 to reduce the image sensor's output amplifier noise. The output of the ASP 228 is then converted to a digital image signal by the A/D converter 230. Interface 232 has outputs for controlling ASP 228, motors 234 and timing generator 226. From interface 232, the digital image data passes over system bus 204 to the internal computer 206.

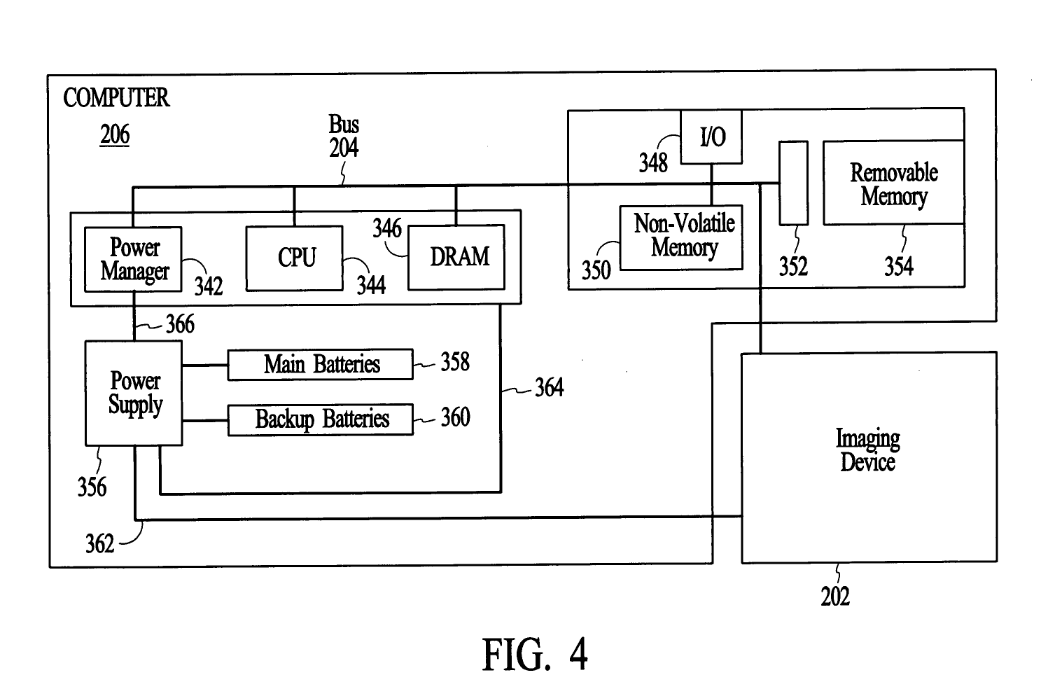

Referring now to FIG. 4, a more detailed block diagram of an embodiment of the internal computer 206 is shown. System bus 204 provides connection paths between imaging device 202, power manager 342, central processing unit (CPU) 344, random-access memory (DRAM, MRAM, FeRAM, etc.) 346, input/output interface (I/O) 348, read-only memory (ROM) 350, and buffers/connector 352. Removable memory 354 connects to system bus 204 via buffers/connector 352. Alternatively, image-capturing device 200 may be implemented without removable memory 354 or buffers/connector 352.

Power manager 342 communicates via line 366 with power supply 356 and coordinates power management operations for image-capturing device 200. CPU 344 typically includes a processor device for controlling the operation of image-capturing device 200. In an embodiment, CPU 344 is capable of concurrently running multiple software routines to control the various processes of image-capturing device 200 within a multi-threading environment. RAM 346 is a contiguous block of dynamic memory which may be selectively allocated to various storage functions.

I/O 348 is an interface device that allows communications to and from computer 206. For example, I/O 348 permits an external host computer (not shown) to connect to and communicate with computer 206. I/O 348 also permits a user to communicate with image-capturing device 200 via an external user interface and via an external display panel.

ROM 350 includes a non-volatile read-only memory which stores a set of computer-readable program instructions to control the operation of image-capturing device 200. Removable memory 354 serves as an additional image data storage area and is a non-volatile device, readily removable and replaceable by a device user via buffers/connector 352. In an embodiment, removable memory 354 is a flash disk.

Power supply 356 supplies operating power to the various components of image-capturing device 200. In an embodiment, power supply 356 provides operating power to a main power bus 362 and also to a secondary power bus 364. The main power bus 362 provides power to imaging device 202, I/O 348, ROM 350 and removable memory 354. The secondary power bus 364 provides power-to-power manager 342, CPU 344 and RAM 346.

Referring back to FIG. 3, image sensor 224 is a sensor with random access capabilities e.g. a Foveon sensor. These types of sensors provide the capability of individually addressing and reading data at pixel locations and color planes of a retrieved image. As a result, selected segments of retrieved data and selected resolutions of retrieved data can be read from the sensor as desired. This capability is utilized to retrieve a sub-set of image data from the sensor. In other words, as the sensor senses a plurality of frames of image data, a sub-set(s) of the plurality of frames can be retrieved and stored in memory for later processing.

Accordingly, for a portion of the sensed plurality of frames a first and a second sub-set of image data of each frame can be retrieved whereby a first type of image is generated from the first sub-set and a second type of image is generated from the second sub-set. In an embodiment, the first type of image is a low-resolution video image and second type of image is a high-resolution still image.

Although the above-referenced embodiment is described in the context of being utilized in conjunction with a Foveon sensor, it should be understood that any sensor with random access capabilities can be utilized while remaining within the spirit and scope of the present invention.

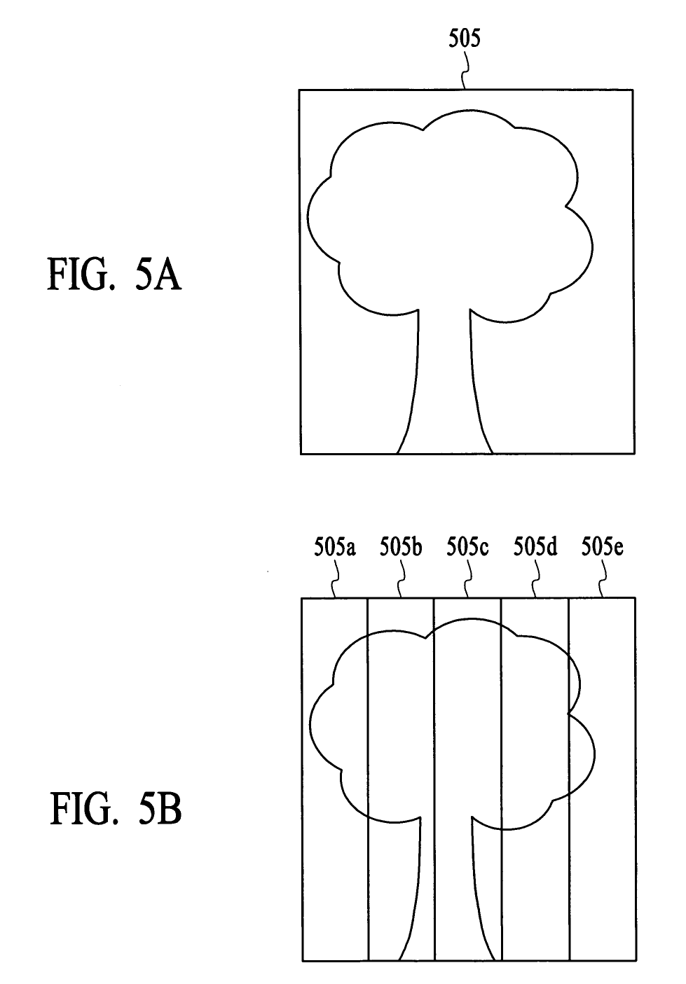

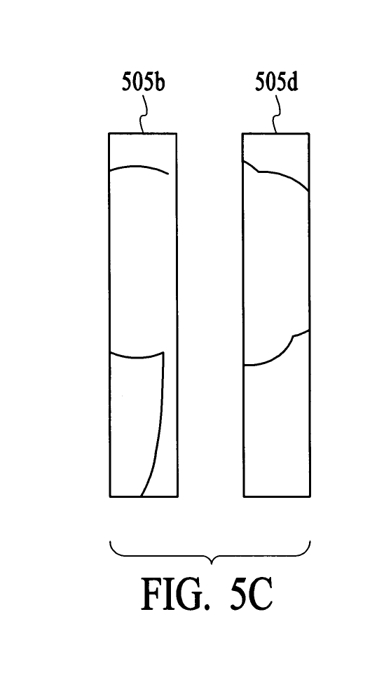

In an embodiment, the second sub-set of image data includes high-resolution “slices” (e.g. 2048×1056 pixels) of a still-image of a scene. For the purposes of this patent application, a “slice” is defined as a partial portion of a frame of retrieved image data. In an embodiment, the slices are retrieved by reading a fraction of the entire width of the camera sensor. For a better understanding, please refer now to FIGS. 5(a)-5(c). FIG. 5(a) shows a scene 505 that is to be retrieved with an image-capturing device. FIG. 5(b) shows the scene 505 broken into five slices 505(a)-505(e). FIG. 5(c) shows isolated slices 505(b) and 505(d) for exemplary purposes.

In an embodiment, each slice 505(a)-505(e) is representative of the corresponding pixel locations of image data retrieved by a sensor. For example, if the entire width of the image data retrieved by the sensor is represented by pixels 1-500, slice 505(a) is representative of pixels 1-100, slice 505(b) is representative of pixels 101-200, slice 505(b) is representative of pixel values 201-300, etc. In order to generate the slice, a frame of retrieved data is downsampled to create a high-resolution portion of the scene 505.

Downsampling includes any means of reading out or representing the high-resolution portion of the scene with less data or fewer pixels than that of the entire retrieved image data of the scene. For example, on some charge-coupled devices, this is accomplished by reading out only some of the rows of pixels. In CMOS sensors, this can be accomplished by skipping rows and columns of pixels, so that only a subset of the pixels are read. In a sensor with random access capabilities, groups of pixels can be averaged together before readout. This allows the high-resolution region (slice) to be represented with a smaller amount of data at the cost of some loss of image quality. In any case, the remaining portion of the frame, i.e. the pixels of the sensor that are not being utilized to retrieve the slice, is discarded.

Accordingly, each slice 505(a)-505(e) is individually retrieved in a high-resolution format and stored in memory for processing at a later time. In an embodiment, the image-capturing device includes a separate high-resolution memory file for storing the high-resolution slices 505(a)-505(e). The slices 505(a)-505(e) are subsequently retrieved from memory and processed in a mosaic fashion to generate a high-resolution still image of the scene 505. What is meant by the term “mosaic fashion” is that the slices 505(a)-505(e) are pieced together to form the high-resolution still image.

Although the above-described embodiment is disclosed whereby 5 regions of the sensor are utilized to retrieve 5 slices, one of ordinary skill in the art will readily recognize that the sensor can be broken into any number of regions while remaining within the spirit and scope of the present invention. The number of regions can be based on the speed of the processor being utilized or a desired quality of the retrieved high-resolution still-image or any number of factors.

Additionally, in an embodiment, the slices are retrieved in an overlapping fashion in order to improve the mosaic processing. In other words, each retrieved high-resolution slice (except the first high-resolution slice) overlaps the previously retrieved high-resolution slice. For example, if the first retrieved high-resolution slice is representative of pixel locations 1-100, a portion of the pixels that are representative of the subsequent slice should overlap pixels 1-100 (e.g. pixel locations 75-175 could be representative of the subsequent slice). The percentage by which the slices overlap each other can be determined empirically or by any of a variety of other suitable means.

In order to facilitate the simultaneous retrieval of a high-resolution still image and a low-resolution video image, a frame-by-frame process is implemented. For example, if the sensor is retrieving a video image of a scene, each digital frame being retrieved is a low-resolution image of the scene. In other words, the sensor of the image-capturing device is read so as to provide a lower resolution image of the scene. Accordingly, a user interaction, for example the pressing of a button on the image-capturing device, triggers the image-capturing device such that the sensor is read so as to provide a high-resolution still image (i.e. the full resolution of the sensor) of the scene being video taped. At this point, the frame-by-frame process is initiated.

In an embodiment, the frame-by-frame process involves utilizing the sensor to retrieve low-resolution frames and high-resolution slices. Accordingly, based on the above-described first and second sub-sets of image data, the first sub-set of image data corresponds to each sensed frame having a first resolution (low-resolution) and the second sub-set of image data corresponds to a partial frame of each sensed frame having a second resolution (high-resolution). Again, the partial frame corresponds to a fraction of a width of the sensor.

In an embodiment, the frame-by-frame process is employed wherein for every sensed frame, each of the first and second sub-sets of image data is retrieved and stored in memory. In an alternative embodiment, frame-by-frame process is employed whereby the first and second sub-sets of image data are retrieved in an alternating fashion wherein one of the first and second sub-sets of image data is retrieved from each sensed frame and the other of the first and second sub-sets of image data is retrieved from every other sensed frame.

For example, if the first sub-set of image data corresponds to low-resolution data and the second sub-set of image data corresponds to high-resolution slices, once the process is initiated, the first frame retrieved by the sensor is a low-resolution image of the scene. Next, the sensor retrieves a high-resolution slice of the image of the scene. As described above, a high-resolution slice is an extracted portion of a frame of retrieved image data. The high-resolution slice is then stored in a memory within the image-capturing device. The next frame of retrieved data is another low-resolution image of the scene. A second high-resolution slice of the image of the scene is then retrieved and stored in memory with the first high-resolution slice wherein the second high-resolution slice is configured to overlap the first high-resolution slice. This process continues until enough high-resolution slices are retrieved to create a high-resolution still image of the scene being video taped.

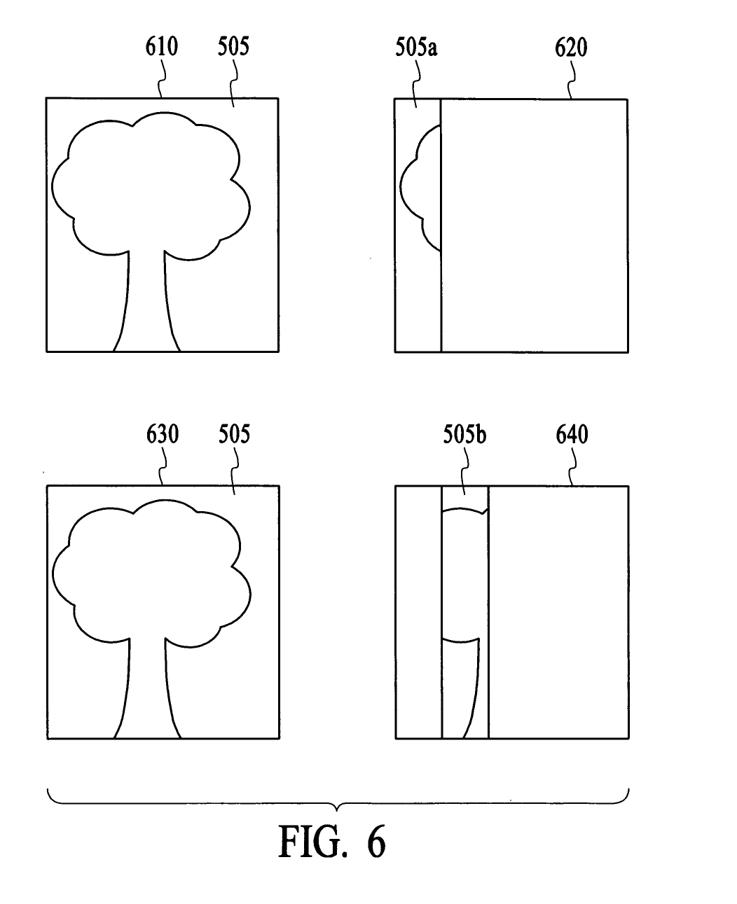

For a more detailed understanding of the frame-by-frame process, please refer now to FIG. 6. FIG. 6 shows four consecutive frames 610-640. The first frame 610 is a low-resolution image of the scene 505. The second frame 620 is downsampled to generate the high-resolution slice 505(a) wherein the slice 505(a) is stored in memory. The third frame 630 is another low-resolution image of the scene 505. The fourth frame is downsampled to generate a second high-resolution slice 505(b) wherein the slice 505(b) is stored in memory. This process is continued until enough high-resolution slices have been retrieved to create a high-resolution still image of the scene 505.

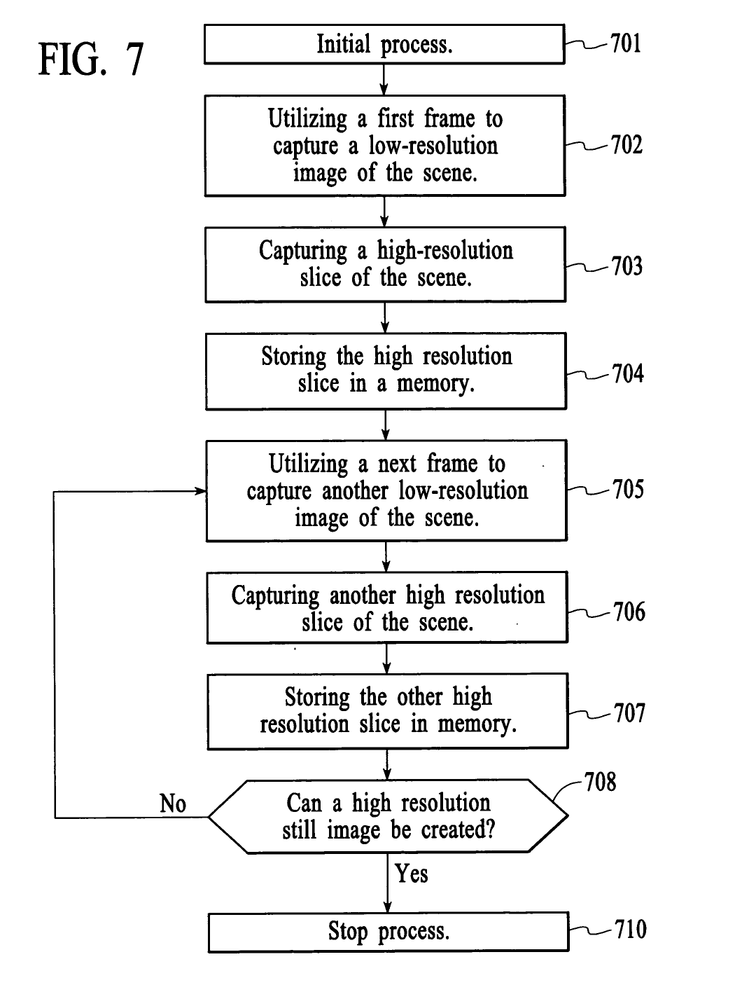

FIG. 7 shows an embodiment of the above-described image capturing process. A first step 701 involves initiating a still-image retrieving process. This is accomplished via a user interaction such as the depressing of a button or the like. A second step 702 involves utilizing a first frame to retrieve a low-resolution image of the scene. A third step 703 involves retrieving a high-resolution slice of the scene. A fourth step 704 involves storing the high-resolution slice in a memory.

A fifth step 705 involves utilizing a next frame to retrieve another low-resolution image of the scene. A sixth step 706 includes retreiving another high-resolution slice of the scene. A seventh step 707 involves storing the another high-resolution slice in a memory. A determination is then made at step 708 as to whether enough high-resolution slices have been retrieved to create a high-resolution still image of the scene. If yes, then the process is stopped. If no, steps 705-708 are repeated until enough high-resolution slices have been retrieved to create a high-resolution still image of the scene.

The number of high-resolution slices that are to be retrieved is dependent upon the size of each slice. The size of each slice should be established so as not to affect the video image. For example, if the high-resolution slices are too big, the low-resolution video image could be “jittery” at the point in the video playback where the high-resolution still-image was retrieved. Additionally, although the high-resolution slices are depicted as being retrieved in a horizontal fashion, a skilled artisan will recognize that the slices could be retrieved in a vertical fashion or any of a variety of other fashions.

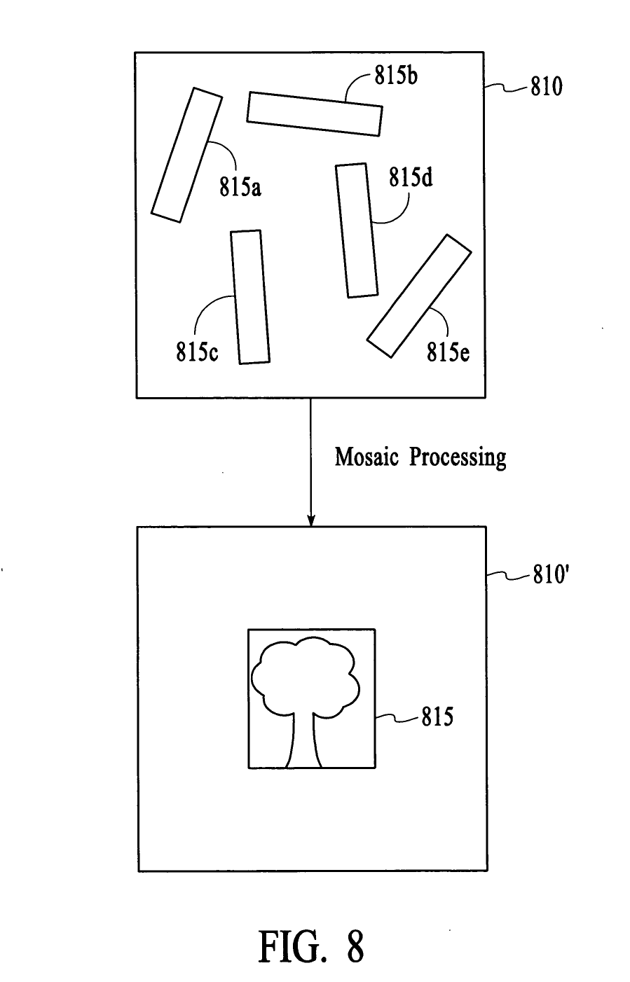

Accordingly, the high-resolution slices 815(a)-815(e) are stored in memory to be processed later in a mosaic fashion. In varying embodiments, the memory could be a removable memory (see item 354, FIG. 4) or a random access memory (see item 346, FIG. 4). FIG. 8 shows a memory 810 that includes high-resolution slices 815(a)-815(e). A processor coupled to the memory 810 subsequently processes the high-resolution slices 815(a)-815(e) in order to generate a high-resolution still-image 815 wherein the high-resolution still-image 815 is made up of the high-resolution slices 815(a)-815(e). FIG. 8 shows the memory 810′ including the high-resolution still-image 815 after the mosaic processing of the high-resolution slices 815(a)-815(e).

The mosaic processing of the high-resolution slices 815(a)-815(e) is accomplished via linear interpolation or any of a variety of other image processing techniques. In an embodiment, the high-resolution slices 815(a)-815(e) are encoded in JPEG format whereby a smart decoder is implemented to pull the JPEG slices out of the memory and generate the high-resolution still-image.

Although, the above-described embodiments are disclosed whereby the first and second sub-sets of image data respectively correspond to low-resolution and high-resolution image data, one of ordinary skill will readily recognize that the sub-sets of image data could be a variety of different types of image data while remaining within the spirit and scope of the present invention. For example, a first sub-set of image data could include all of the color planes (Red, Green, Blue) and the second sub-set of image data could only include a portion of the color planes (Red, Green).

The above-described embodiment of the invention may also be implemented, for example, by operating a system to execute a sequence of machine-readable instructions. The instructions may reside in various types of computer readable media. In this respect, another aspect of the present invention concerns a programmed product, comprising computer readable media tangibly embodying a program of machine-readable instructions executable by a digital data processor to perform the method in accordance with an embodiment of the present invention.

This computer readable media may comprise, for example, RAM contained within the system. Alternatively, the instructions may be contained in another computer readable media (e.g. an image-processing module) and directly or indirectly accessed by the computer system. Whether contained in the computer system or elsewhere, the instructions may be stored on a variety of machine readable storage media, such as a Direct Access Storage Device (DASD) (e.g., a conventional “hard drive” or a RAID array), magnetic data storage diskette, magnetic tape, electronic non-volatile memory, an optical storage device (for example, CD ROM, WORM, DVD), or other suitable computer readable media including transmission media such as digital, analog, and wireless communication links.

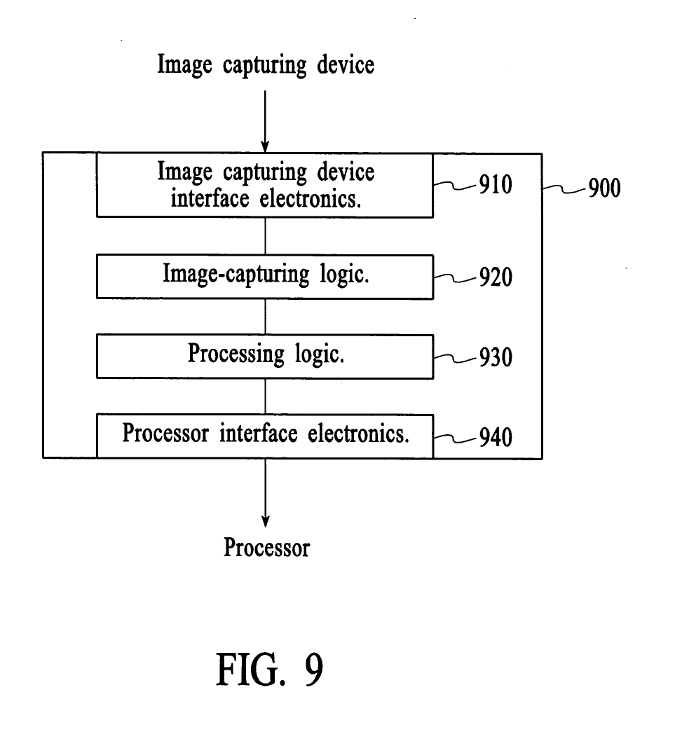

For an example of an image-processing module in accordance with an embodiment, please refer now to FIG. 9. FIG. 9 shows an image-processing module 900. The module 900 includes image-capturing device interface electronics 910, image-retrieving logic 920, processing logic 930 and processor interface electronics 940. The image-capturing device interface electronics 910 are coupled to the image-retrieving logic 920 wherein the image-retrieving logic 920 is further coupled to the processing logic 930. The processing logic 930 is further coupled to the processor interface electronics 940.

Although the components of the above-described image-processing module 900 are shown in a specific configuration, one of ordinary skill in the art will readily recognize the components of the image-processing module 900 could be configured in a variety of ways while remaining within the spirit and scope of the present invention.

The image-capturing device interface electronics 910 and the processor interface electronics 940 include the electronic circuitry employed by the image-processing module 900 to respectively communicate with an image-capturing device and a processor. Image-retrieving logic 920 includes logic for retrieving a high-resolution still-image of a scene while simultaneously retrieving a video image of the scene. This logic includes information related to the sensor regarding the fractional portion of the sensor that is to be used to retrieve each high-resolution slice, the amount by which the slices are to overlap each other, etc.

Processor logic 930 includes logic for processing the retrieved high-resolution slices and creating the high-resolution still image. The processing is accomplished via linear interpolation or any of a variety of other image processing methodologies. This logic can be based on the speed of the processor, the size of the high-resolution slices, the desired quality of the high-resolution still image, etc.

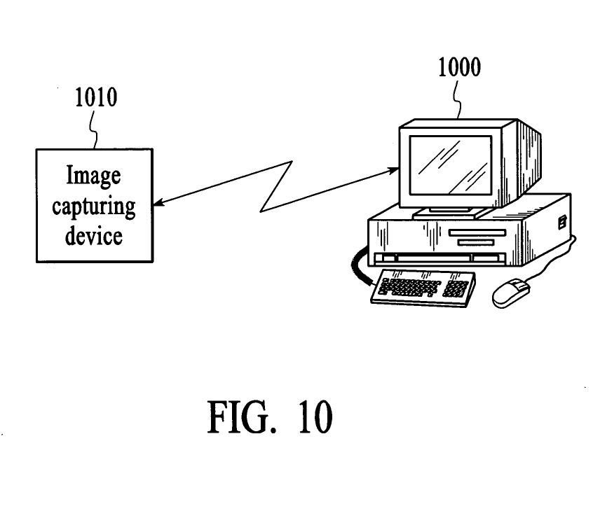

In an embodiment, the image-processing module 900 may be implemented as one or more respective software modules operating on a computer system wherein the computer system is coupled to or integrally incorporates an image-capturing device. FIG. 10 shows a configuration whereby an image-capturing device 1010 is coupled to a computer system 1000. The image-capturing device 1010 can be coupled to the computer system 1000 via a cable connector, wireless connection means or any of a variety of types of connection methodologies.

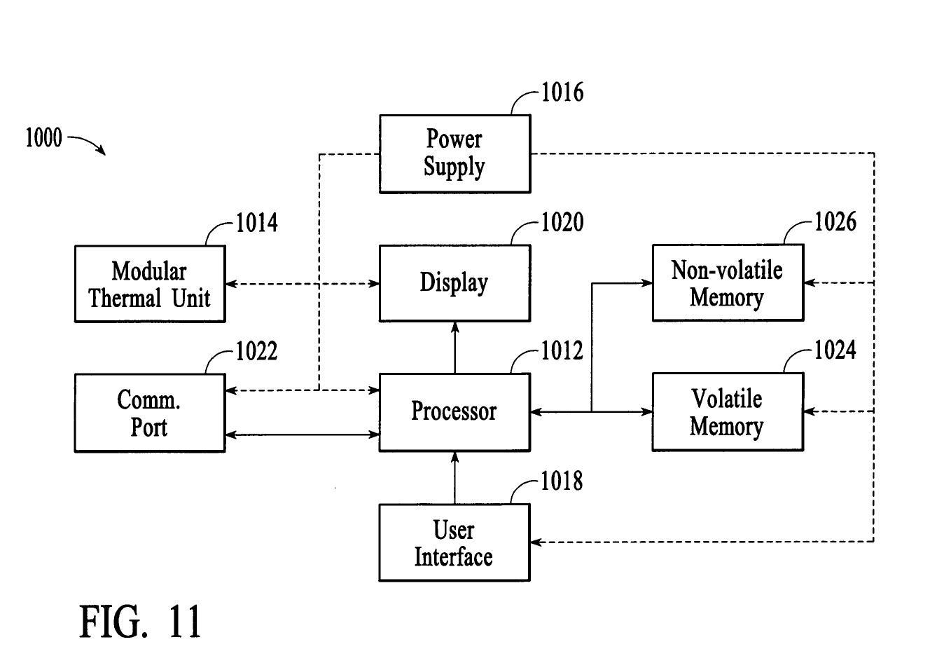

FIG. 11 shows a block diagram of an exemplary computer system, generally designated by the reference numeral 1000, is featured. Computer 1000 may be any of a variety of different types, such as a notebook computer, a desktop computer, an industrial personal computer, etc. In the illustrated embodiment, a processor 1012 controls the functions of computer system 1000. In this embodiment, data, as illustrated by the solid line, is transferred between the processor 1012 and the components of system 1000. Additionally, a modular thermal unit 1014 is used to remove heat from the processor 1012. Computer 1000 also includes a power supply 1016 to supply electrical power, as illustrated by the dashed line, to the components of computer system 1000.

Computer system 1000 may incorporate various other components depending upon the desired functions of computer 1000. In the illustrated embodiment, a user interface 1018 is coupled to processor 1012. Examples of a user interface 1018 include a keyboard, a mouse, and/or a voice recognition system. Additionally, an output device 1020 is coupled to processor 1012 to provide a user with visual information. Examples of an output device 1020 include a computer monitor, a television screen, a printer or the like. In this embodiment a communications port 1022 is coupled to processor 1012 to enable the computer system 1000 to communicate with an external device or system, such as a printer, another computer, or a network.

Processor 1012 utilizes software programs to control the operation of computer 1000. Electronic memory is coupled to processor 1012 to store and facilitate execution of the programs. In the illustrated embodiment, processor 1012 is coupled to a volatile memory 1024 and non-volatile memory 1026. A variety of memory types, such as DRAMs, SDRAMs, SRAMs, etc., may be utilized as volatile memory 1024. Non-volatile memory 1026 may include a hard drive, an optical storage, or another type of disk or tape drive memory. Non-volatile memory 1026 may include a read only memory (ROM), such as an EPROM, to be used in conjunction with volatile memory 1024.

Accordingly, once the image-capturing device 1010 is coupled to the computer system 1000, computer system 1000 implements image-processing module 900 in order to allow the image-capturing device 1010 to simultaneously retrieve a high-resolution still-image of a scene while retrieving a video image of the scene.

A method and system for processing an image with an image-capturing device is disclosed. The present invention allows a user to simultaneously retrieve a high-resolution still-image of a scene while retrieving a video image of the scene. By allowing a user to simultaneously retrieve a high-resolution still-image of a scene while retrieving a video image of the scene, a user no longer has to switch back and forth between a video image mode and a still-image mode in order to retrieve a high-resolution still image of a scene.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

1. A method of processing an image of a scene with an image-capturing device, the image-capturing device including a sensor, the method comprising:
sensing a plurality of frames of image data with the sensor;
retrieving a sub-set of the image data;
storing the sub-set of image data in a storage component of the image-capturing device; and
generating an image of the scene with the sub-set of image data.

2. The method of claim 1 wherein the image-capturing device comprises a digital camera.

3. The method of claim 1 wherein the image-capturing device comprises a digital camcorder.

4. The method of claim 1 wherein retrieving a sub-set of the image data further comprises:
retrieving a first and second sub-set of image data from a portion of the plurality of frames of image data;
generating a first type of image from the first sub-set of image data; and
generating a second type of image from the second sub-set of image data.

5. The method of claim 1 wherein retrieving a sub-set of the image data further comprises:
removing at least one color from each of the plurality of frames of data.

6. The method of claim 4 wherein each the first type of image is a video image and the second type of image is a still image.

7. The method of claim 4 wherein each first sub-set corresponds to a full frame of each sensed frame having a first resolution and each second sub-set corresponds to a partial frame of each sensed frame have a second resolution.

8. The method of claim 4 wherein the one of the first and second sub-sets of image data comprises a plurality of high-resolution slices of each of the plurality of frames of image data.

9. The method of claim 4 wherein retrieving a sub-set of the image data further comprises utilizing a frame-by-frame process to retrieve the sub-set of image data.

10. The method of claim 8 wherein retrieving a first and second sub-set of image data from a portion of the plurality of frames of image data further comprises:
utilizing a sensor with random access capabilities to retrieve each of the plurality of high-resolution slices wherein each of the plurality of high-resolution slices comprises a portion of a digital frame wherein the portion corresponds to a fraction of a width of the sensor.

11. The method of claim 8 wherein generating an image of the scene with sub-set of image data:
processing the plurality of high-resolution slices to form a high-resolution still-image.

12. The method of claim 9 wherein one of the first and second sub-sets are retrieved for every sensed frame and the other of the first and second sub-sets are retrieved for a portion of the plurality of frames.

13. The method of claim 9 wherein one of the first and second sub-sets is retrieved for every sensed frame and the other of the first and second sub-sets is retrieved for every other sensed frames.

14. The method of claim 10 wherein the sensor comprises a Foveon sensor.

15. The method of claim 11 wherein at least one of the plurality of high-resolution slices overlaps another of the plurality of high-resolution slices.

16. The method of claim 11 wherein processing the plurality of high-resolution slices to form the still-image further comprises:
utilizing linear interpolation to process the plurality of high-resolution slices.

17. A system for capturing an image of a scene with an image-capturing device comprising:
means for sensing a plurality of frames of image data with the sensor;
means for retrieving a sub-set of the image data;
means for storing the sub-set of image data in a storage component of the image-capturing device; and
means for generating an image of the scene with sub-set of image data.

18. The system of claim 17 wherein the means for retrieving a sub-set of the image data further comprises:
means for retrieving a first and second sub-set of image data from a portion of the plurality of frames of image data;
means for generating a first type of image from the first sub-set of image data; and
means for generating a second type of image from the second sub-set of image data.

19. The system of claim 17 wherein retrieving a sub-set of the image data further comprises:
means for removing at least one color from each of the plurality of frames of data.

20. The system of claim 18 wherein each the first type of image is a video image and the second type of image is a still image.

21. The system of claim 18 wherein each first sub-set corresponds to a full frame of each sensed frame having a first resolution and each second sub-set corresponds to a partial frame of each sensed frame have a second resolution.

22. The system of claim 18 wherein the one of the first and second sub-sets of image data comprises a plurality of high-resolution slices of each of the plurality of frames of image data.

23. The system of claim 18 wherein means for retrieving a sub-set of the image data further comprises means for utilizing a frame-by-frame process to retrieve the sub-set of image data.

24. The system of claim 22 wherein the means for retrieving a first and second sub-set of image data from a portion of the plurality of frames of image data further comprises:
means for utilizing a sensor with random access capabilities to retrieve each of the plurality of high-resolution slices wherein each of the plurality of high-resolution slices comprises a portion of a digital frame wherein the portion corresponds to a fraction of a width of the sensor.

25. The system of claim 22 wherein the means for generating an image of the scene with sub-set of image data further comprises:
means for processing the plurality of high-resolution slices to form a high-resolution still-image.

26. An image-capturing device comprising:
a sensor wherein the sensor is configured to capture high-resolution portions of a still-image of a scene while simultaneously capturing a low-resolution video image of the scene; and
a processor coupled to the sensor for processing the captured high-resolution portions of the still-image.

27. The image-capturing device of claim 26 wherein the image-capturing device comprises a digital camera.

28. The image-capturing device of claim 26 wherein the image-capturing device comprises a digital camcorder.

29. The image-capturing device of claim 26 wherein the high-resolution portions comprises high-resolution slices of the scene.

30. The image-capturing device of claim 29 wherein the sensor includes random access capabilities to capture each of the plurality of high-resolution slices wherein each of the plurality of high-resolution slices comprises a portion of a digital frame wherein the portion corresponds to a fraction of a width of the sensor.

31. The image-capturing device of claim 29 wherein the processor is configured to process the plurality of high-resolution slices to form the still-image.

32. The image-capturing device of claim 31 wherein the processor utilizes linear interpolation to process the plurality of high-resolution slices and generate a high-resolution still-image.

33. An image-processing module for an image-capturing device comprising:
image-capturing logic for utilizing a frame-by-frame process to capture a high-resolution slices of a still-image of a scene while simultaneously capturing a video image of the scene; and
processing logic for processing the captured high-resolution slices of the still-image.
